(19) United States
(12) Patent Application Publication
(10) Pub. No.: US 2007/0093232 A1
(43) Pub. Date: Apr. 26, 2007

(54) MANAGEMENT OF AN ALERT SIGNAL FOR A TELECOMMUNICATIONS DEVICE

(76) Inventor: Gary Stephen Shuster, Fresno, CA (US)

Correspondence Address: CONNOLLY BOVE LODGE & HUTZ LLP, P.O. BOX 2207, WILMINGTON, DE, 19899, US

(21) Appl. No.: 11/552,073

(22) Filed: Oct. 23, 2006

Related U.S. Application Data
(60) Provisional application No. 60/729,403, filed on Oct. 21, 2005.

(51) Int. Cl. H04B 1/06; H04M 3/00

(52) U.S. Cl. 455/355; 455/419

(57) ABSTRACT

A mobile communication device alert signal may be remotely controlled by transmitting an alert control signal to the mobile communication device when the mobile communication device is within a predefined area, the alert control signal to indicate to the mobile communication device to invoke a control procedure for its alert signal.

### CROSS-REFERENCE TO RELATED APPLICATION

This application claims priority pursuant to 35 U.S.C. § 119(e) to U.S. provisional application Ser. No. 60/729,403, filed Oct. 21, 2006, which application is specifically incorporated herein, in its entirety, by reference.

### BACKGROUND OF THE INVENTION

1. Field of the Invention

Embodiments of the present invention may relate to telecommunication systems and, more specifically, to telecommunication devices and their management.

2. Description of Related Art

The ubiquitous nature of cellular and other mobile communication devices, while providing a great deal of convenience, has also led to some unintended negative consequences. For example, many mobile communication devices are equipped with audible alert signals to alert the users that a call is being initiated, that a message has arrived, or some similar communication event. Similarly, such devices may also be equipped with alarm clocks or similar notification features. Audible alert signals may be triggered, however, at inconvenient and/or embarrassing times, for example, during a concert, lecture, or class, or in the middle of a crowded restaurant, thus disturbing other attendees or patrons.

Owners or operators of physical spaces where such disturbances are unwelcome have, in the past, attempted to control such sounds with signage requesting that phones be silenced, but such measures have not been uniformly successful. Some establishments have also employed wall coatings that prevent signal penetration; however, this has the drawback of preventing even emergency wireless signals from being received. Another measure that has been considered has been the use of signal blocking devices that jam the frequencies on which such mobile communication devices operate; however, this may be unlawful.

### SUMMARY OF THE INVENTION

Embodiments of the present invention may provide a system, method, and/or software to address the above problems by inhibiting an audible alert signal and/or by substituting an inaudible alert signal for an audible alert signal. This may be done in response to the reception of a signal notifying a mobile communication device to perform such inhibiting or switching.

### BRIEF DESCRIPTION OF THE DRAWINGS

A more complete understanding of various embodiments of the invention will be afforded to those skilled in the art by a consideration of the following detailed description of the such embodiments in conjunction with the attached drawings in which:

FIG. 1 shows a conceptual diagram of a system according to various embodiments of the invention;

FIG. 2 shows a conceptual block diagram of a mobile communication device according to various embodiments of the invention;

FIG. 3 presents a flowchart of a method according to an embodiment of the invention;

FIG. 4 presents a flowchart of another method according to an embodiment of the invention; and

FIG. 5 is a conceptual block diagram of a system that may be used to implement various embodiments of the invention.

### DETAILED DESCRIPTION OF THE VARIOUS EMBODIMENTS OF THE INVENTION

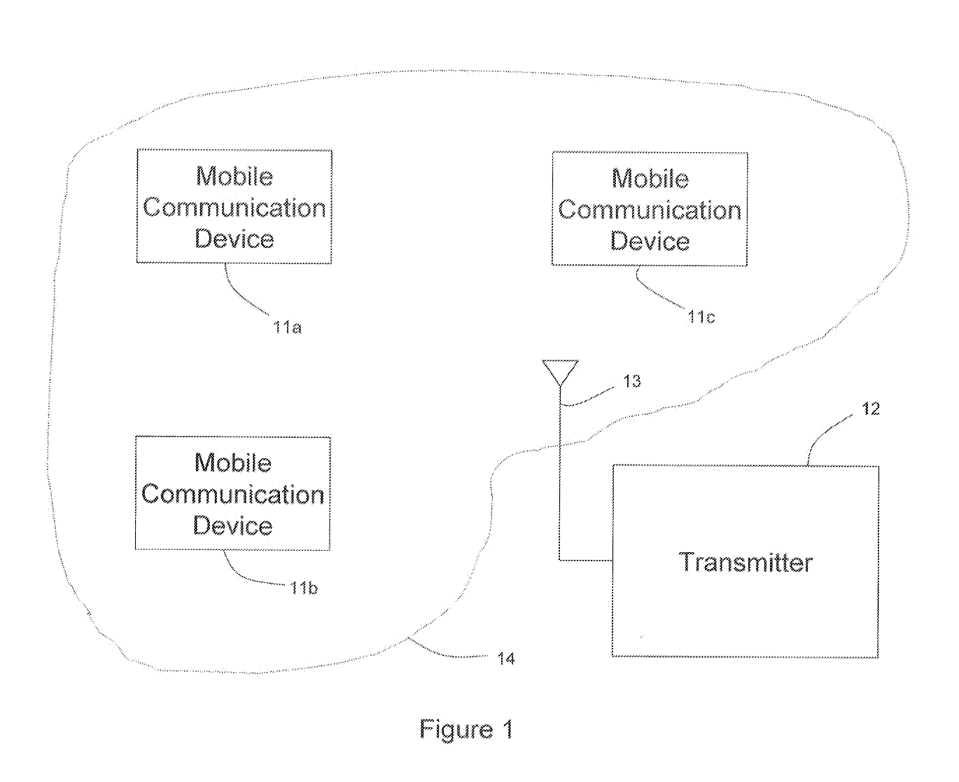

FIG. 1 shows a conceptual block diagram of a system according to various embodiments of the invention. In the system of FIG. 1, a transmitter 12 may be employed to transmit an alert control signal within some predefined area 14. Predefined area 14 may, for example, correspond approximately to a restaurant, theater, building, etc. Transmitter 12 may be equipped with an antenna 13 to enable transmission within predefined area 14. For example, antenna 13 may include a directional antenna to limit an area into which the alert control signal is transmitted. A predefined area 14 may, furthermore, require more than one transmitter 12 to fully cover the predefined area 14. Mobile communication devices 11a-11c within the predefined area 14 may be able to detect the transmitted alert control signal, while mobile communication devices outside predefined area 14 may not be able to detect the alert control signal.

The alert control signal may comprise a beacon or other type of signal. It may also be integrated into a format of a regular signaling protocol, for example, but not limited to CDMA2000, GSM, AMPS, UMTS, Bluetooth, WiFi, WiMax, and other well-known protocols. The alert control signal may take the form of a particular message or code or of a particular type of encoded signal (for example, but not limited to, use of a particular spreading code or other type of bit sequence). The alert control signal may be a radio frequency (RF) signal, but it may alternatively be an infrared (IR) signal, a visible frequency signal, an audio frequency signal, or any other type of signal that may be appropriate. The alert control signal may also include security encoding that may be recognized only by a mobile communication device 11 having the capability to decode the security encoding, which may prevent an unauthorized individual from blocking alert signals.

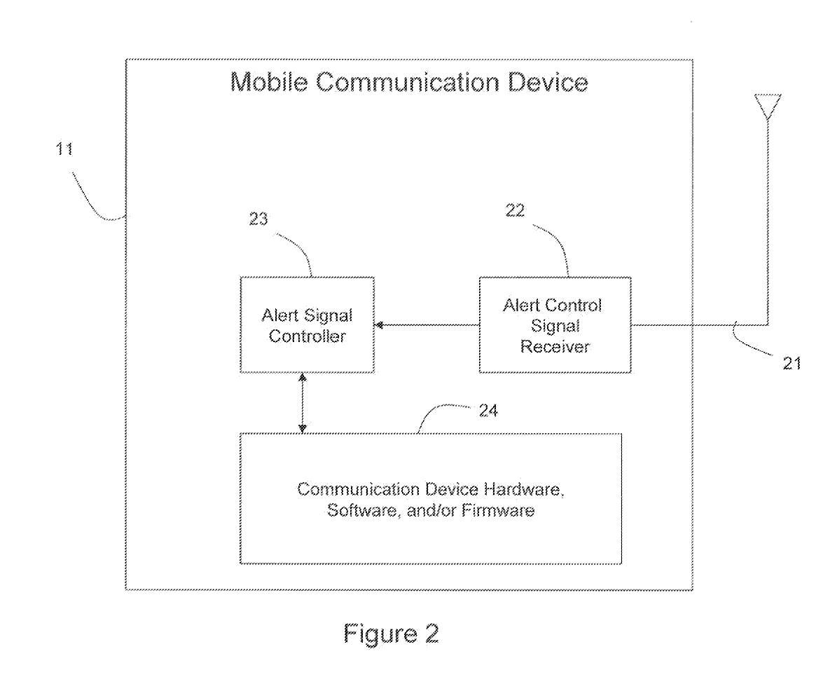

FIG. 2 shows a block diagram of a mobile communication device 11 in accordance with an embodiment of the invention. A mobile communication device 11 may include an antenna 21 and an alert control signal receiver 22 to scan for, receive and/or detect the alert control signal. While shown as separate components in FIG. 2, antenna 21 and/or alert control signal receiver 22 may alternatively be integrated into the communication device hardware, software, and/or firmware 24. Alternatively, antenna 21 may be a receiving device appropriate for non-RF signal (e.g., but not limited to, a photodiode or other IR signal detector). The alert control signal receiver 22 may provide an indicator to an alert signal controller 23. The alert signal controller 23 is shown as a separate component in FIG. 2, but it may, alternatively, be integrated into communication device hardware, software, and/or firmware 24. The indicator that may be provided by alert control signal receiver 22 may let the alert signal controller 23 know if the alert control signal has been detected and/or when it ceases to be detected. If the alert control signal has been detected, then the alert signal controller 23 may take appropriate action, upon receiving the indicator from alert control signal receiver 22. Such action may include one or more of, for example, squelching an audible alert signal (e.g., ring), lowering the volume of an audible alert signal, switching the device to an inaudible alert signal mode of operation, switching to an alert signal transmitted only through an earpiece, and/or alerting a user of the mobile communication device to change the alert signal or turn off the mobile communication device. Upon receiving from alert control signal receiver 22 an indication that the alert control signal is no longer present, the alert signal controller 23 may revoke the previously invoked alert signal controls and/or notify the user that he/she may do so.

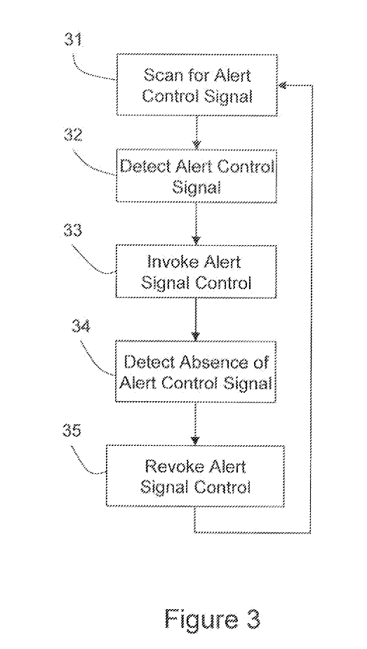

FIG. 3 shows a flowchart of a procedure that may be implemented in a mobile communication device according to an embodiment of the invention. Mobile communication device 11 may scan 31 for the presence of an alert control signal. If an alert control signal is detected 32, alert control may be invoked 33, as discussed above (for example, but not limited to, by adjusting the alert signal volume or eliminating it or switching to a different type of alert signal or by notifying the user). As part of detection 32, the mobile communication device may optionally detect the strength of the alert control signal. In this latter case, signal strength may be compared to a threshold to determine whether the signal is strong enough to warrant invoking alert control 33 and/or may be used to set volume reduction to a particular, level, which may, for example, be according to proximity to the signal source. The mobile communication device 11 may continue to scan, and when it detects that the alert control signal is no longer present 34, it may revoke the alert control that was previously invoked 35. This revocation may, for example, take the form of restoring the mobile communication device's alert signal to what it was previous to invoking alert control and/or notifying the user of the mobile communication device.

In a further embodiment, said scanning may scan for an alert control override signal. Such an alert control override signal may be transmitted, for example, by emergency personnel, in order to override any alert control in case of an emergency.

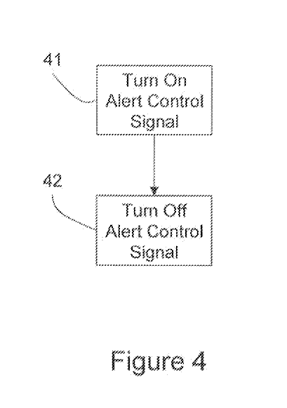

FIG. 4 shows a flowchart of a procedure that may be implemented by an establishment wishing to employ such alert control, according to an embodiment of the invention. The establishment may turn on the alert control 41, for example, when the establishment opens for business, when a performance begins, or during some other period of time during which audible alert signals may be undesirable. The establishment may, upon the termination of such a period of time, turn of the alert control signal 42, thus permitting audible alert signals to be reinstated in mobile communication devices within the predefined area associated with the establishment. The turning on or off of the alert control signal transmitter 12 may be performed, for example, manually, by a user, automatically (e.g., by programming on and/or off times) and/or remotely (e.g., by remote control through a communication network, such as, but not limited to, the Internet or any other wired or wireless communication network).

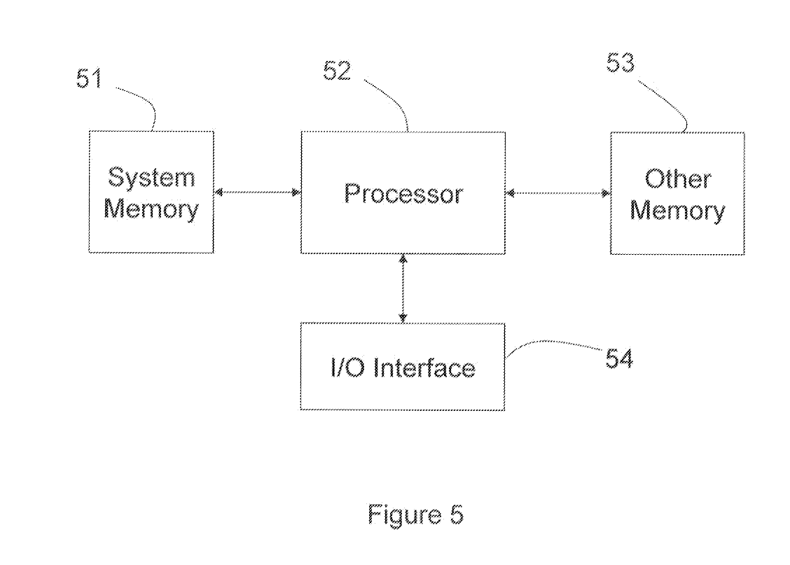

FIG. 5 shows a conceptual block diagram of a system that may be used to implement all or part of various embodiments of the invention. Such a computing system may include one or more processors 52, which may be coupled to one or more system memories 51. Such system memory 51 may include, for example, RAM, ROM, or other such processor-readable media, and system memory 51 may be used to incorporate, for example, a basic I/O system (BIOS), operating system, instructions for execution by processor 52, etc. The system may also include further memory 53, such as additional RAM, ROM, hard disk drives, or other processor-readable media. Processor 52 may also be coupled to at least one input/output (I/O) interface 54. I/O interface 54 may include one or more user interfaces, as well as readers for various types of storage media and/or connections to one or more communication networks (e.g., communication interfaces and/or modems), from which, for example, software code may be obtained. Such a computing system may, for example, be integrated into and/or used to implement all or portions of mobile communication device 11 and/or transmitter 12.

Various embodiments of the invention have now been discussed in detail; however, the invention should not be understood as being limited to these embodiments. It should also be appreciated that various modifications, adaptations, and alternative embodiments thereof may be made within the scope and spirit of the present invention. Consequently, the scope of the invention is defined by the attached claims.

What is claimed is:

1. A mobile communication device, comprising:
an alert control signal receiver to scan for and to detect an alert control signal; and
an alert signal controller coupled to receive from said alert control signal receiver an indicator of the presence or absence of said alert control signal, the alert signal controller further to invoke an alert signal control upon receiving an indicator of the presence of said alert control signal.

2. The mobile communication device according to claim 1, wherein said alert signal control comprises one or more procedures selected from the group consisting of:
turning off an audible alert signal;
reducing a volume of an audible alert signal;
switching from an audible alert signal to an audible alert signal;
switching from an audible alert signal to an alert signal transmitted only through an earpiece; and
informing a user of the mobile communication device to take action.

3. The mobile communication device according to claim 1, wherein said alert control signal receiver is integrated as part of mobile communication device hardware, software, or firmware.

4. The mobile communication device according to claim 1, wherein said alert signal controller is integrated as part of mobile communication device hardware, software, or firmware.

5. The mobile communication device according to claim 1, wherein said alert signal controller is further adapted to revoke said alert signal control upon receiving an indicator of the absence of said alert signal.

6. The mobile communication device according to claim 1, further comprising:
a radiation receiving device coupled to said alert control signal receiver to provide a signal to said alert control signal receiver.

7. The mobile communication device according to claim 6, wherein said radiation receiving device is selected from the group consisting of: an antenna, an infrared receiver, a visible light receiver, and an audible signal receiver.

8. The mobile communication device according to claim 1, wherein said alert control signal receiver is further adapted to measure the strength of said alert control signal.

9. The mobile communications device according to claim 8, wherein said alert control signal receiver is adapted to provide said indicator only if the strength of said alert control signal exceeds a predetermined threshold.

10. The mobile communications device according to claim 8, wherein said alert control signal receiver is further adapted to provide the strength of said alert control signal to said alert signal controller, and wherein said alert signal controller is further adapted to adjust an audible alert signal volume based on said strength.

11. An mobile communication device alert signal control system, comprising:
a transmitter to transmit an alert control signal within a predefined area, the alert control signal to signal a mobile communication device within the predefined area to invoke an alert signal control procedure.

12. The mobile communication device alert signal control system according to claim 11, wherein said transmitter comprises at least one transmitter selected from the group consisting of: an RF transmitter; an infrared transmitter, a visible light transmitter, and an audible signal transmitter.

13. The mobile communication device alert signal control system according to claim 11, wherein said transmitter is coupled to a communication network to receive a control signal to turn the transmitter on or off.

14. The mobile communication device alert signal control system according to claim 11, further comprising:
a timing device to control when said transmitter is turned on and off.

15. A method of controlling an alert signal of a mobile communication device, the method comprising:
scanning for an alert control signal;
detecting the presence of said alert control signal;
invoking an alert signal control in response to said detecting;
detecting the cessation of said alert control signal; and
revoking said alert signal control in response to detecting the cessation of said alert control signal.

16. The mobile communication device according to claim 15, wherein said alert signal control comprises one or more procedures selected from the group consisting of:
turning off an audible alert signal;
reducing a volume of an audible alert signal;
switching from an audible alert signal to an inaudible alert signal;
switching from an audible alert signal to an alert signal transmitted only through an earpiece; and
informing a user of the mobile communication device to take action.

17. The method according to claim 15, wherein said detecting includes measuring a strength of said alert control signal, and wherein said alert signal control comprises adjusting a volume of an audible alert signal according to said strength.

18. A processor-readable medium containing machine-executable instructions that, when executed by a processor, to cause the processor to implement a method comprising:
scanning for an alert control signal;
detecting the presence of said alert control signal;
invoking an alert signal control in response to said detecting;
detecting the cessation of said alert control signal; and
revoking said alert signal control in response to detecting the cessation of said alert control signal.

19. The medium according to claim 18, wherein said alert signal control comprises one or more procedures selected from the group consisting of:
turning off an audible alert signal;
reducing a volume of an audible alert signal;
switching from an audible alert signal to an inaudible alert signal;
switching from an audible alert signal to an alert signal transmitted only through an earpiece; and
informing a user of the mobile communication device to take action.

20. The medium according to claim 18, wherein said detecting includes measuring a strength of said alert control signal, and wherein said alert signal control comprises adjusting a volume of an audible alert signal according to said strength.

21. A method of controlling an alert signal of a mobile communication device, the method comprising:
transmitting an alert control signal within a predefined area, the alert control signal to signal a mobile communication device within the predefined area to invoke an alert signal control procedure.

22. The method according to claim 21, further comprising:
initiating said transmitting at a first time corresponding to a starting time of an event; and
ceasing said transmitting at a second time corresponding to an ending time of an event.

23. The method according to claim 22, wherein said initiating and said ceasing are performed responsive to a timing device.

24. The method according to claim 21, further comprising:
receiving one or more control signals via a communication network to indicate when to perform at least one operation selected from the group consisting of: initiating said transmitting and ceasing said transmitting.

25. A processor-readable medium containing machine-executable instructions that, when executed by a processor, to cause the processor to implement a method comprising:
transmitting an alert control signal within a predefined area, the alert control signal to signal a mobile communication device within the predefined area to invoke an alert signal control procedure.

26. The medium according to claim 25, containing further machine-executable instructions that, when executed by said processor, cause said method to further comprise:
receiving an indication from a communication network to initiate or to cease said transmitting.

27. The medium according to claim 25, containing further machine-executable instructions that, when executed by said processor, cause said method to further comprise:
causing said transmitting to begin or to end at a preset time.
